(19) United States
(12) Patent Application Publication
(10) Pub. No.: US 2015/0186965 A1
(43) Pub. Date: Jul. 2, 2015

(54) COMPUTERIZED DEVICE, SYSTEM, AND METHOD FOR COORDINATING AN OUTFIT

(71) Applicant: Salsberg Paul, Toronto (CA)

(72) Inventor: Salsberg Paul, Toronto (CA)

(21) Appl. No.: 14/141,858

(22) Filed: Dec. 27, 2013

(51) Int. Cl. G06Q 30/06; G06F 17/30; G06F 17/22; G06K 9/46; G06K 9/00

(52) U.S. Cl. CPC G06Q 30/0613; G06K 9/4652; G06K 9/00362; G06F 17/2247; G06F 17/30725

(57) ABSTRACT

Articles of fashion with tags, computerized systems, methods, and mobile devices with computer program products installed thereon that enable a user to create a coordinated ensemble without the assistance of a fashion stylist. Embodiments comprise: 1) a fashion article comprising a permanent tag with a URL and a temporary tag with a QR code, both directing the user to a webpage disclosing the article's features, such as: size, care instructions, materials, designer, etc.; 2) a website service to analyze matching colors, and display other products that mix and match, and expert fashion advice; and, 3) a mobile device with a camera and a mobile app to analyze and display the color values (CMYK and/or Pantone) in an article and a user's skin tone, and compute matching colors to enable the user to create a coordinated ensemble in features comprising color, style, texture, etc.

### FIELD OF THE INVENTION

The present disclosure is generally directed to a web-based service and an electronic computing device with a mobile app for enabling users to create a coordinated outfit or ensemble.

### BACKGROUND OF THE INVENTION

It is not uncommon for a novice dresser to erroneously mix and match fashion articles to create an ensemble that “clashes” in texture, style, and/or coloring. Therefore, they often require the assistance of stylists or store employees to assist them in coordinating an outfit.

A fabric's texture refers to the tactile and/or visual sensation is triggers. Tactile is texture that can be felt by the touch (smooth, leather, etc.). Visual is texture that can be seen (matte, dull, shiny). An ensemble has clashing textures when the fabrics are mismatches in tactile and/or visual qualities, such as silk fabric with metallic material.

The “style” of clothing may be used in the fashion industry to indicate the fashion category and/or fashion subculture that an ensemble fits into. The term may thus refer to the image or theme the wearer is trying to project, such as: classic, preppy, punk, heavy metal, sophisticated, sporty, vintage, western, nautical, etc.

The color of an item of clothing may be derived from a color wheel as shown in FIG. 1. A color wheel is normally divided into twelve equal sections, each section representing a different color indicating its pigment value. Red, blue, and yellow are “primary” colors because they cannot be made by mixing other colors together, and they form an equidistant triangle on the color wheel. Mixing equal amounts of any two of the primary colors produces the “secondary” colors violet, orange, and green. Lastly, “tertiary” colors lie between the primary and secondary colors and are created by adding equal amounts of them to create: red-orange; orange-yellow; yellow-green; blue-green; blue-violet; and violet-red.

Color coordinating a fashionable outfit, or ensemble, using colors defined by such a color wheel may comprise intentionally selecting analogous colors in a primary (e.g. pants) and secondary (e.g. shirt) article. Analogous colors are three colors next to each other on a color wheel; therefore, an ensemble comprising them is expected to be easy on the eye. On the other hand, complementary colors are opposite each other on the color wheel, so an ensemble comprising them would make the wearer standout, which is not the intended effect if the s/he is trying to create a sophisticated impression.

In the fashion industry, the twelve colors of the color wheel are not sufficient to describe the multitude of different pigments used in fabrics, often with ten or more dominating any particular fashion season. Therefore, other methods have been developed to designate color pigments. For example, Cyan-Magenta-Yellow-Black (CMYK) is a color model in which all colors are described as a mixture of these four process colors. A CMYK color identification code (e.g. C:29 M:38 Y:54 K:2) is four digit, with each digit representing the relative amount or percentage of cyan (29%), magenta (38%), yellow (54%) or black (2%) in a color.

Likewise, Pantone is another standardized color matching system often used in the fashion industry. The Pantone Solid palette consists of 1,341 colors, identified by three or four digit numbers, followed by a C or U suffix. Automated tools exist for converting CMYK to Pantone color identification codes, and vice versa.

What is needed within the fashion industry are various tools to assist a shopper (online, mobile app, or in the store) to efficiently create a coordinated ensemble (in texture, style, color, etc.) without requiring the assistance of other individuals, such as store personnel. This includes having information about a fashion article (i.e. an article of clothing) readily available to the user. Examples of such are the following: the name of the designer or brand, care instructions, material (e.g. % organic cotton), color and even the article's unique features (such as heat absorbing technology, uniqueness of the thread, etc.).

### SUMMARY OF THE INVENTION

The present disclosure comprises various embodiments to assist an in-store shopper of clothing with Internet access via an electronic computing device (e.g. mobile device), to create an outfit that is coordinated in style, texture, color, etc. The user may be shopping to coordinate the outfit using fashion articles that they already own, and/or they may be comparing various articles that they are considering purchasing.

In one or more aspects of the present invention, a user's electronic computing device with a computer program product installed upon it (e.g. “mobile app”), is utilized to compute an article's color identification code, and then to assist the user in searching online or in-person (within a store or their home closet) for articles with matching color codes to create a coordinated ensemble. The user would scan each item physically or online to see if they possess the matching colors.

Additional aspects of the invention comprise utilizing the user's electronic computing device to access a web site comprising additional fashion coordination features. One aspect comprises one or more tags attached to an article of fashion (e.g. clothing), wherein one tag is permanently attached to the article and comprises a URL with a unique identification code specific to the article (e.g. www.myfashionmatch.com:ID#484042). By typing the URL into an electronic computing device web browser (e.g. laptop), or scanning it in with a mobile device, the user will be directed to a webpage displaying a full description about features of the article of clothing, such as cleaning and care instructions, material compositions (e.g. cashmere), color & unique features (e.g. single breasted jacket).

The article may also comprise a removable tag comprising a quick response (QR) code that encodes the same or a similar URL as the permanent tag's, which comprises a unique identification code specific to the article. When the user scans the QR code with their mobile device, they will be directed to the same or a similar webpage as encoded in the permanent tag's link. The webpage will disclose one or more of the following: a full description about features of the article of clothing, such as cleaning and care instructions, material compositions, and color & unique features.

Another aspect comprises a web-based system and computerized method of directing a user to a website that provides assistance to the user to create a coordinated ensemble by displaying for each article one or more of the following features:
1) a description of the article and why it is unique (e.g. stitching, pockets, etc.); material composition; color(s); care instructions (e.g. dry clean only); and size. The user can see the recommended ensemble wherein recommendations are only from the same designer/brand; and/or,
2) recommendations from professional stylists for any item in an ensemble of a complete outfit and from a combination of any designer/brand; and/or,
3) a method of color matching the ensemble or outfit, via manual or automated means:
   a) Manual: the user selects from a drop down menu (or other similar means) a dominant color they have judged to be in their item of clothing. In response, the website, and/or computer program product installed on the user's electronic computing device, calculates what all of its matching colors are and displays them along with their CMYK and/or Pantone color identification code.
   b) Automated (with one clothing item): A user scans a fashion article with an electronic computing device (e.g. smartphone comprising scan app); the processor computes and displays the CMYK and/or Pantone color identification code for each color in the article of clothing; and then displays matching colors with their CMYK and/or Pantone code (e.g. FIG. 8A-C).
   c) Automated (skin tone): A user's electronic computing device scans a forearm or wrist image of the user and computes their skin shade, which is assigned a CMYK and/or Pantone color identification code. The device then computes and displays colors (and their CMYK and/or Pantone color identification code) that match the skin tone color identification code (e.g. FIG. 9).
   d) Automated (with two clothing items):
      i) User scans one primary item (such as pants) with an electronic computing device (e.g. smartphone comprising a generic image scanning mobile app). The user then scans a secondary item, such as a shirt, in an effort to make a coordinated ensemble. The program would then determine if the primary and secondary items match in color. If they do not, then the primary item would remain and the user would then find another secondary item to scan and compare (FIG. 10). The primary and secondary items may be in the user's physical possession, or they may be an online image. The app will assign a percentage and comment such as “non-match, fair, good, very good, and excellent” to inform the user of how well the items coordinate.
      ii) The computer program product can also factor in the user's skin color identification code (see supra 3(b)) when computing matching colors of two clothing items. The device can compute and display the color compatibility between a primary and secondary fashion article, such as in percentages (e.g. 85% compatibility), and then the device can factor in the user's skin tone color identification code (e.g. dropping compatibility to 70%) (FIG. 11).
   e) The user can also save within memory on their electronic computing device with the computer program product (e.g. mobile app) installed thereon, the types of clothes in their wardrobe, such as pants, shirts, skirt etc., as well as their color identification codes. They can then scan the QR code on an article's tag in a store item, or utilize the color analysis mobile app, to determine if it coordinates with their existing wardrobe of saved items. The purpose of this feature is to allow the user to purchase new items that can potentially match with one or items in his/her existing wardrobe.

As per the outline supra, a website of the present invention will automatically display fashion articles with matching colors from, for example, a store's on-line catalogue.

In another aspect, a user's electronic computing device (e.g. “mobile device”) with a computer program product installed in it (e.g. “mobile app”), can compute the color identification code of a user's skin shade and display colors that match the skin shade color identification code.

In another aspect, a user's electronic computing device (e.g. “mobile device”) with a computer program product installed in it (e.g. “mobile app”), can compute the color identification code of a primary and secondary article of fashion, and compute whether the two codes are a “color match”. The computation of “a match” may further comprise computing a percentage of compatibility of the two color codes based upon a color wheel (e.g. see FIG. 1) including: complementary color scheme, analogous color scheme, triadic color scheme, split-complementary color scheme, rectangular color scheme, and square color scheme.

In another aspect, a user's electronic computing device (e.g. “mobile device”) with a computer program product installed upon it (e.g. “mobile app”), can further use the computed user's skin color identification code to compute a color match with a fashion article, such as a dress, shirt, blazer.

In another aspect, a user's electronic computing device (e.g. “mobile device”) with a computer program product installed in it (e.g. “mobile app”) can further use the computed user's skin identification code as an additional factor or variable when computing the color compatibility of a primary and secondary fashion article.

In one or more aspects of the present invention, the color may be computed and displayed in CMYK and/or Pantone color identification codes. And/or the user may request the system (mobile app or remote server) to convert from one color designation (CMYK—Pantone) to the other, and display it on the user's device screen.

### Web-Based Service

The present invention may further comprise a web-based service (i.e. “first website”) to facilitate a user to create a coordinated ensemble; and, to enable a manufacturer and/or retailer to market their fashion line to the website's users. The service may comprise one or more of the following features:
a) displaying images of a selection of fashion articles by their specific type (e.g. pants, shirts—see FIG. 13) that enables the user to search for a particular article by their product identification code typically located on the clothing label on the back of a shirt or pants;
b) details about a particular fashion article, and other fashion articles that would match it (e.g. FIG. 14), and (optionally) a link to the retailer's website to purchase a matching article that is advertised on the first website; and,
c) the option of viewing a fashion expert's (stylist's) written advice for a particular fashion article (e.g. FIG. 15).

### Option #1 (Included in Myfashionmatch for Free)

Any item with a QR code tethered to a clothing item will already have a stylist review. The stylist receives the clothing item in advance and offers advice on what to pair it up with. Hence, when the QR code is scanned a stylist statement is already written. When we charge a clothing company the item placement fee, it actually covers the price to upload and describe the clothing item in detail (the manufacturer's info) along with 1-2 stylist's reviews.

### Option #2 (Pay Per Use Service)

This stylist option may further comprise a user video chatting in real-time with a stylist, wherein the stylist is able to view the user's article from the stylist's computing device after the user scans in its QR code or image, such as two articles in their closet, or one or more items they from a store. The stylist can then transmit advice, verbal or written, to the user such as whether their two articles match, and/or recommendations for other articles within the first website's database comprising images and product identification codes. The stylist's fee may be paid by the user, be part of a website subscription service, or be covered by the retailer or manufacturer of a product line that is advertised on the first website.

The present invention may also comprise a web-based service which involves a web administrator who creates an account on a remote database for third parties to advertise their fashion line. The third parties, such as manufactures and retailers, compensate the first website operators for uploading and maintaining their fashion line within the first website's database. (e.g. FIG. 12—“Manage Brand”). The third parties may sell articles with the temporary or permanent clothing tags as disclosed herein that direct the user's to the administrator's website, and/or they may advertise by other means on the administrator's computer program product (e.g. mobile app) of the present invention (e.g. logos, promotional offers, etc.).

### BRIEF DESCRIPTION OF THE DRAWINGS

The present invention will now be further described through various embodiments in reference to the accompanying drawings comprising:

FIG. 1 is an illustration of a color wheel and a table demonstrating five primary methods of matching colors using the wheel.

FIG. 2 is a schematic diagram of the user electronic computing device within a retail store communicating with a remote system server.

FIG. 3 is a box diagram of the user's electronic computing device with the computer program product (i.e. “mobile app”) of the present disclosure installed upon it.

FIGS. 4A-C comprise illustrations of images of the embodiment comprising an article of clothing with tags attached identifying the features of the article.

FIG. 4A is an exemplification of an article of clothing with a permanent tag comprising a URL link and a temporary tag comprising a QR code.

FIG. 4B is an exemplification of the permanent tag attached to the article.

FIG. 4C is an exemplification of the temporary tag that is attached to the article, wherein the tag comprises a QR code with a URL to a webpage describing features of the article.

FIG. 5 is a flowchart of computer steps followed by the user's electronic computing device in scanning a QR code displayed on a tag attached to an article, and being directed to a webpage describing the article.

FIG. 6 is a flowchart of computer steps for the “manual method” of the system processor computing the matching colors for an article.

FIG. 7 is a flowchart of computer steps for the “automated method” of the user's electronic computing device in computing the main colors of an article (i.e. “article's colors”) and then its “matching colors”.

FIGS. 8A-C is an illustration of smartphone screen shots of shirt color analyzed using the method of FIG. 7.

FIG. 8A is a screen shot of a user scanning an image of an item of apparel into their electronic computing device.

FIG. 8B is a screen shot of the device's processor computing and displaying the CMYK values in the apparel.

FIG. 8C is a screen shot of the device's processor computing and displaying the matching CMYK and/or Pantone values to the values computed in FIG. 8B.

FIG. 9 is a flowchart of computer steps for computing the color value of a user's skin tone, and using that to calculate matching colors.

FIG. 10 is a flowchart of computer steps for computing if two fashion articles together create a color coordinated ensemble.

FIG. 11 is a flowchart of computer steps for computing if one or two fashion articles in combination with a user's skin tone color create a color coordinated ensemble.

FIG. 12 is a screen shot of a webpage on a website for a web administrator to manage the brands or label names of apparel items shown on various webpages of the website.

FIG. 13 is a screen shot of a webpage on a website for a web administrator or retailer to add or delete apparel items per each type.

FIG. 14 is a screen shot of a webpage that would be displayed when an apparel's permanent or removable tag is scanned into the user's device.

FIG. 15 is a screen shot of a webpage for a web administrator to add or delete expert stylists.

### DETAILED DESCRIPTION OF THE INVENTION

### Glossary of Terms

As disclosed herein, the term “Article” or “Fashion Article” refers to any item of a coordinated outfit or ensemble, to include clothing, accessories, shoes, pursues, scarves, etc.

As disclosed herein, the term “Features” refers to the special or distinguishing characteristic of an article that are disclosed on the retailer's webpage, such as cleaning and care instructions, material compositions (e.g. % organic cotton), color, unique features (e.g. breast pocket) and other descriptions the manufacturer/retailer provides.

As disclosed herein, the term “Clothing Article Type” or just “Type” refers to a fashion article's description of its basic type of item of clothing (e.g. pants, short sleeve shirt, etc.), and any distinguishing features—functional or appearance wise (e.g. button down shirt, plaid print, etc.). A style listed on the website could comprise “Long-sleeved shirt in woven fabric with printed pattern. Button-down collar and one chest pocket. Regular fit.”

As disclosed herein, the term “Texture” refers to both or either one of the two types of texture commonly used in the fashion industry: tactile and/or visual. Tactile is texture that can be felt by the touch (smooth, leather, etc.). Visual is texture that can be seen (matte, dull, shiny).

As used herein, the term “Mobile or Client Electronic Computing Device” or “Mobile Device” refers to an electronic communications device with Internet connectivity and camera imaging and scanning of images. In particular, the device has the ability to scan and process QR codes comprising a URL and immediately directing the device's web-browser to the webpage encoded in the URL. The device also has the ability and scan an image of the article, and then compute the various colors within the article, and other colors that match them. The device comprises smartphones, tablets, laptops, etc. In a preferred embodiment, the user's device is an iOS Internet-enabled device with the scanning modules installed to read and process QR codes.

As used herein, the terms “Module” and “Algorithm” refer to a portion of a computer program or software code that carries out a specific function and may be used alone or combined with other modules or algorithms of the same program.

As used herein, the term “QR code” refers to a code printed on a tag temporarily attached to the article. The QR code comprises black modules (square dots) arranged in a square grid on a white background, which can be read by an imaging device (such as a mobile phone camera or scanned using a smartphone or tablet. The data is extracted from patterns present in both horizontal and vertical components of the image. In the present disclosure, the data comprises a URL address for a webpage on a retailer's website that describes the features of the article to which the tag is attached.

### System Architecture

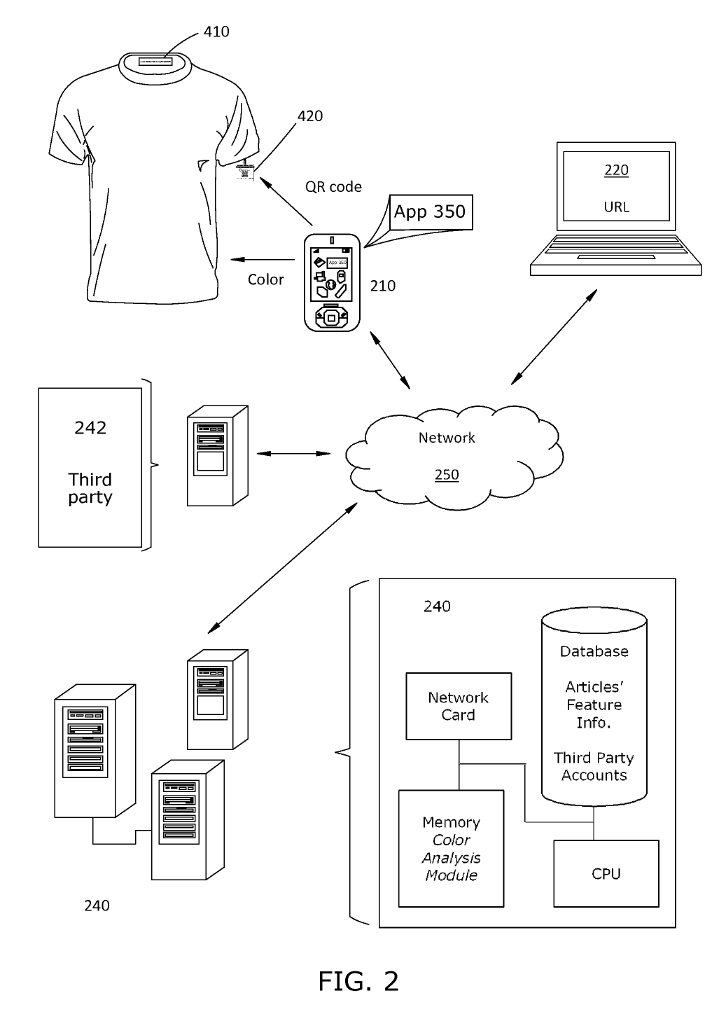

FIG. 2 is a schematic diagram of the system of the present disclosure comprising of a user electronic computing device 210 with Internet connectivity (e.g. smartphone) within a retail store or user's home communicating with a remote system server 240 (“of first website”). The user's client computing device 210 takes a picture of the article 270, and scans the image using the color interpretation computer program product 350 and/or other generic scanning software installed on the device (i.e. scanning of QR code). The scanned image is used by the processor of device 210 to read the QR code 430 displayed on the tag 420 attached to the article 260; and/or, compute the CMYK and/or Pantone color identification code of the various colors in the article 260.

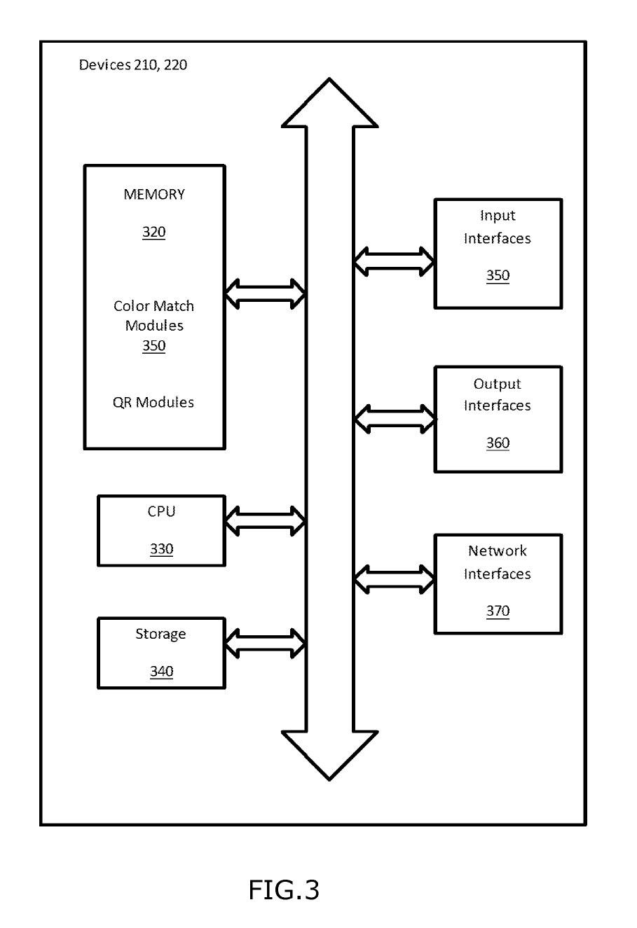

The user's device 210 may further have installed within its memory a color analysis mobile app as per FIG. 3 to compute the CMYK and/or Pantone color identification codes of articles from their scanned images without having to access the first website server 240 via the network 250. Automated tools well known to the artisan exist for converting CMYK to Pantone color identification codes, and vice versa.

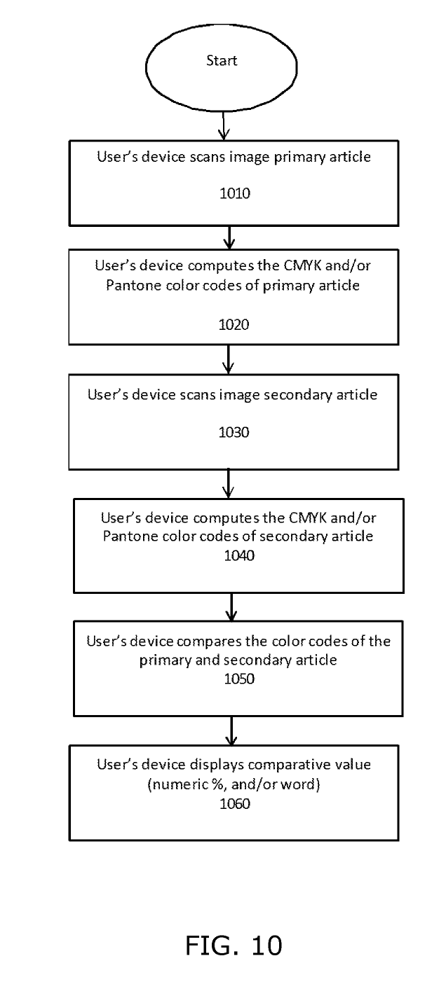

The system may have additional user electronic computing devices 220, such as a laptop, desktop, tablet, etc. with Internet connectivity. Devices 220 can be used to navigate to and utilize the fashion coordination services of the first website server 240 (e.g. see FIGS. 10-12). For example, the user can log into the website via device 220 and use computer software (aka computer code) stored on the remoter server 240 to scan and analyze their skin tone and colors of fashion articles, update their wardrobe and their preferences, enter a URL code from a tag to find matching articles, etc.

Devices 210 and 220 communicate through the network 250 with a remote system server 240, such as a first website server, and with third party servers 242 (e.g. retailers and manufactures who advertise on the first website). Devices 210 and 220 may navigate via a posted link to a third party server's website when they indicate on the first website that they would like to purchase a listed product.

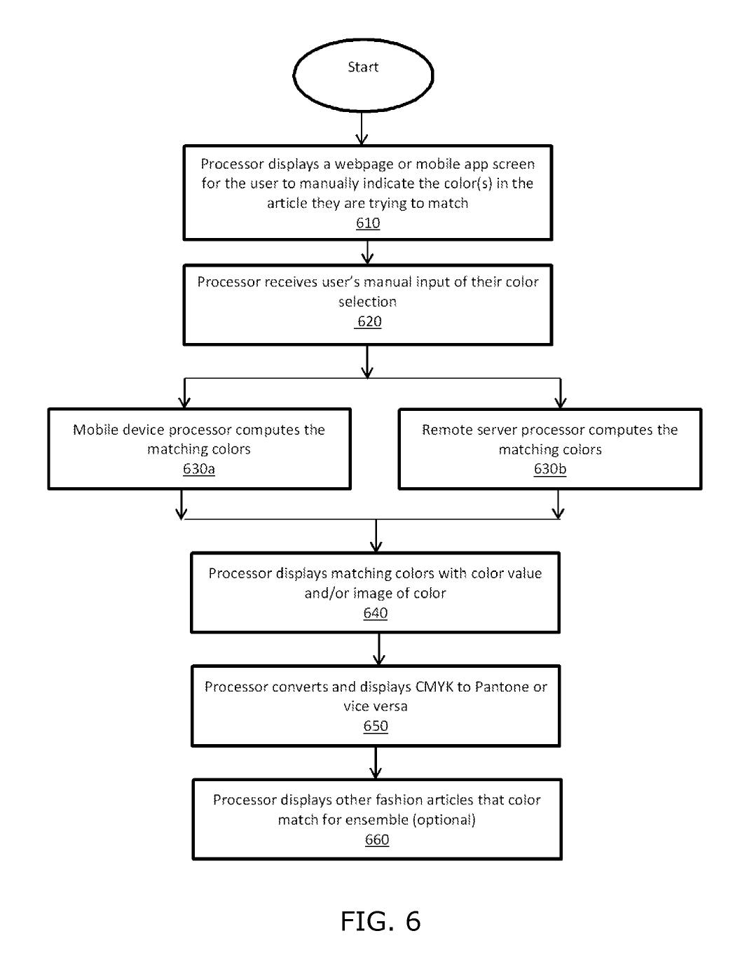

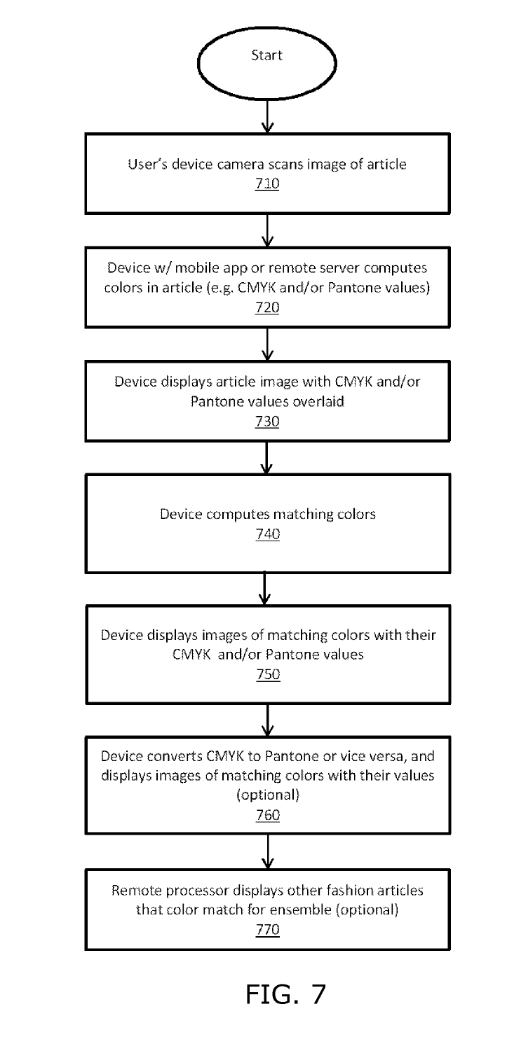

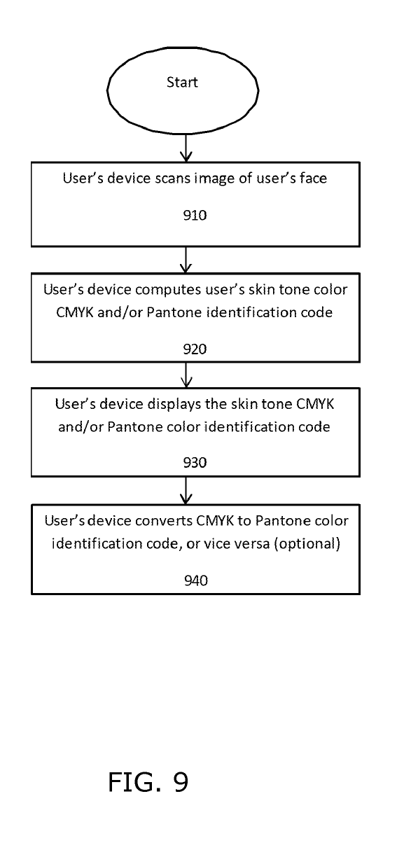

Server 240 comprises a network connection, one or more central processing units (CPU's), a memory storing amongst other software, the color analysis modules as disclosed in FIGS. 6 and 7, and a database storing data records for their advertised product lines and stylists information (e.g. FIGS. 9-12). The database may further comprise records for each retailer and/or manufacturer (i.e. third party) of a product line (e.g. brand) that advertises on the first website. The third party may also link their product line to the first website by labelling their in-store articles with tags 410 and 420 that directs them to the first website to view information comprising the article's distinguishing features, such as its care instructions, materials, designer, price, etc.

Network 250 may comprise the Internet that the user's electronic computing device 210, 220 may connect to via a variety of methods, such as a phone modem, wireless (i.e. smartphone 210-cellular, satellite, microwave, infrared, radio, etc.) network, Local Area Network (LAN), Wide Area Network (WAN), or any such means as necessary to communicate to the system server 240.

### User's Electronic Computing Device

FIG. 3 is a box diagram of the user's electronic computing device with the computer program product (i.e. “color analysis mobile app”) 350 of the present disclosure installed upon it. The devices may comprise a device 210 (e.g. smartphone), and/or 220 (e.g. laptop, desktop, tablet) when a program 350 or the like is installed on device, or is accessible at the remote server 240 via the network 250. The devices 210, 220 comprise a system bus 310 that is connected to various components including one or more of the following components: memory 320, central processing unit (CPU) 330, storage 340, user input interfaces (e.g. touch screen or key input) 350, output interfaces 360, and network interfaces 370.

In one embodiment as illustrated in FIG. 3, the device's memory stores the color analysis modules—computer program product 350 that computes the colors of an article and/or user's skin tone/undertone and displays matching colors and their CMYK and/or Pantone identification code or value. The memory comprises one or more non-transitory computer readable media that includes information or instructions for manipulating data, and may be accessed by the CPU through system bus (e.g. ROM, RAM, etc.).

In another embodiment, or aspect, memory 330 may further comprise modules to scan and process the QR code from the article's tag (e.g. camera capturing QR code image via scanning app).

The devices' CPU executes the instructions provided on computer readable media, such as on memory, a magnetic hard disk, a removable magnetic disk, a magnetic cassette, an optical disk, or from a communication connection, which may also be viewed as a non-transitory computer readable medium.

The storage may be incorporated into, or it may be peripheral to, or it may be removable from the device, such as hard disk drives, and optical disk drives.

Input interfaces 350 enable a user to enter data and/or instructions to the device 210, 220 through one or more corresponding input devices, such as an image scanner w/camera, a touch screen, a keyboard, a mouse, etc. Similarly, examples of input interfaces that may be used to connect the input devices to the bus 310 include a serial port, a parallel port, a game port, a universal serial bus (“USB”), a firewire (IEEE 1394), or another interface.

Output interfaces connect one or more corresponding output devices to the system bus, such as a monitor or display screen, a speaker and a printer. An output device can integrated with or peripheral to device, such as a video adapter, an audio adapter, a parallel port, and the like.

Devices 210 and 220 are in communication with the server 240 via network interfaces (wireless means for Internet connectivity). The network interface 370 enables the device 210, 220 to exchange information and may include hardwired and/or wireless links. Examples of network interfaces include a network adapter for connection to a local area network (“LAN”) or a modem, wireless link, or other adapter for connection to a wide area network (“WAN”), such as the Internet. In a networked system, accessible program modules or portions thereof may be stored in a remote memory storage device.

### Article Tags

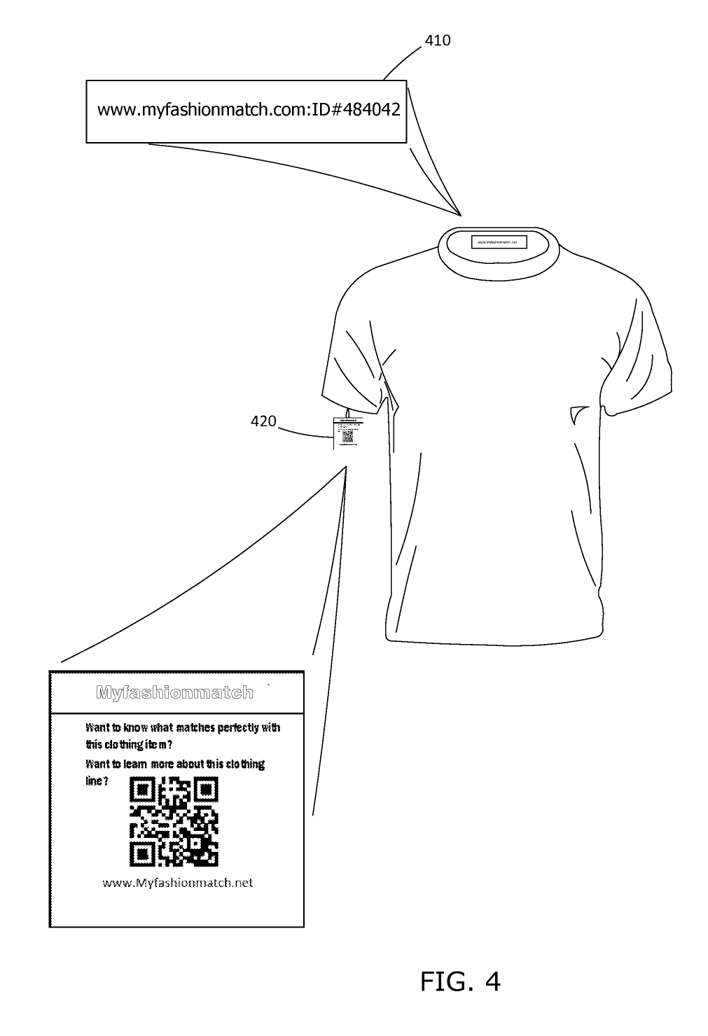

One embodiment of the present disclosure comprises an article with one permanent tag 410 and one temporary tag 420 comprising a QR code, as illustrated in FIG. 4.

FIG. 4, 410 is an exemplification of an article of clothing with a permanent tag comprising a URL link and a temporary tag encompassing a QR code. Although the figure shows the tags attached at a particular location on the article, it is understood that the disclosure is not limited to the placement of the tags at any location so long as it does not damage or impede the appearance or functionality of the article. For example, the permanent tag 410 would not be placed on the outside of the article, or any place where is may be seen through the material when viewed from the outside surface of the article.

FIG. 4, 410 is an exemplification of the permanent tag (“www.myfashionmatch.com:ID#484042”). The permanent tag may comprise a URL with a product identification code. When the user enters this URL into a web-browser, they are directed to a webpage disclosing features of the specific product.

FIG. 4, 420 is an exemplification of the temporary tag that is attached to the article, wherein the tag comprises a QR code with a URL to a webpage describing features of the article. The URL encoded in 410 and 420 may be the same or different. For example, the permanent tag 410 may disclose information that the user who was the owner would need over a long period of time, such as care instructions and material composition, while the temporary tag 420 may disclose information that a user who was considering purchasing the article would need, such as the price and size of the article. Additionally, or alternatively, both tags 410 and 420 may disclose a full description about features of the article of clothing, such as brand name, cleaning and care instructions, material compositions (e.g. cashmere), color & unique distinguishing features (e.g. single breasted jacket).

### QR Code Processing

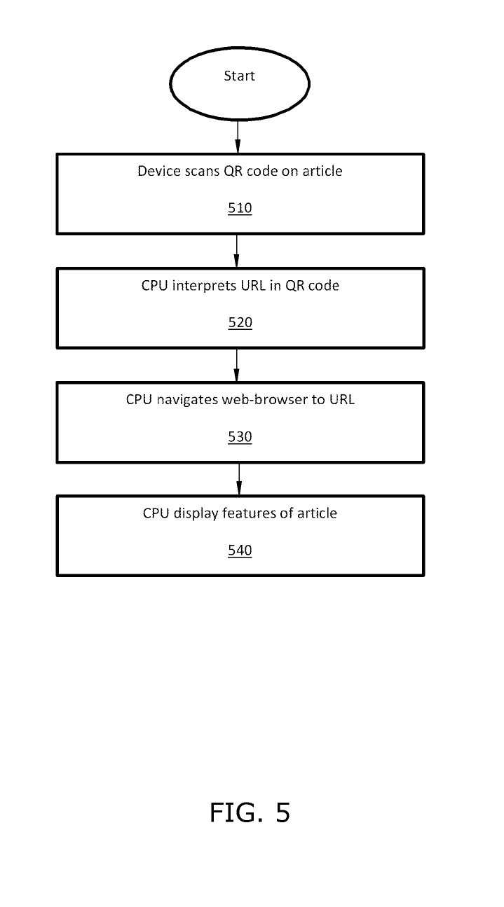

FIG. 5 provides a flowchart of steps taken by the user's electronic computing device in processing the QR code on the tag. When the user scans the QR code displayed on a tag that is attached to an article with a smartphone camera, they are automatically directed to a webpage of a website disclosing features about that particular article. QR scanner applications are native to, or may be installed by the user on, their smartphone 210.

The steps of the CPU of device 210 comprise: scanning the QR code attached to the article (step 510); decoding the URL embedded in the QR code (step 520); navigating the web-browser of device 210 to the URL (step 530); and, displaying features of the article on a webpage encoded by the URL (step 540).

### Color Analysis

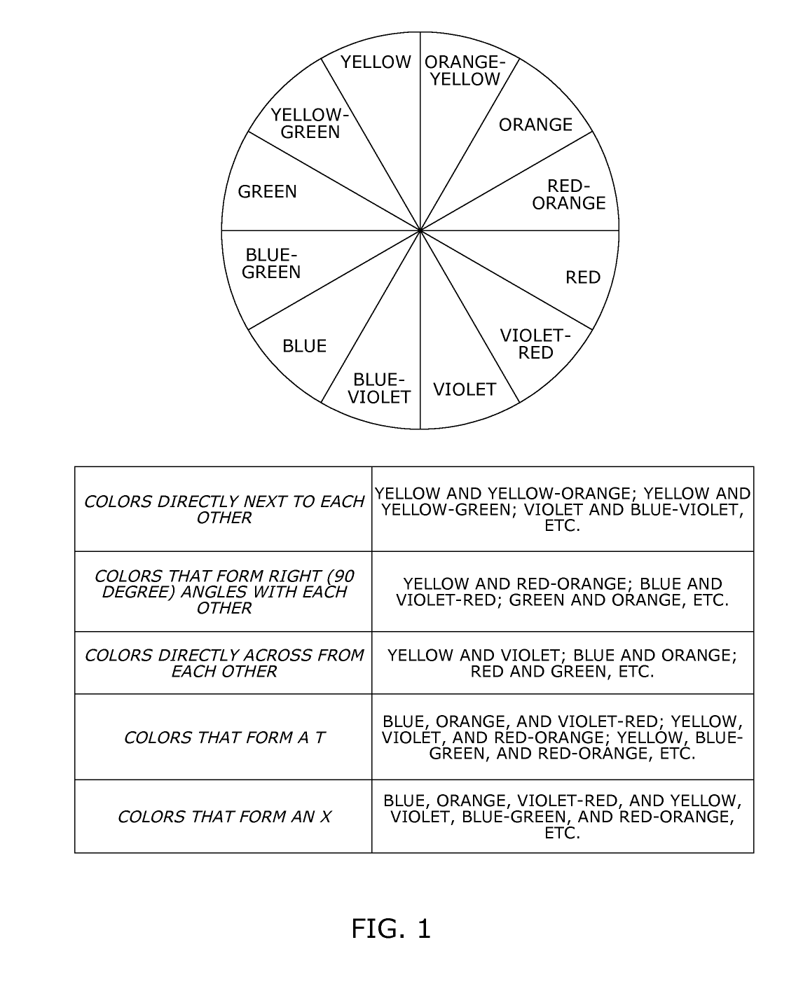

The present disclosure further comprises computerized methods of analyzing the main colors of an article, and then computing colors that match the main colors. Colors may match via five primary types derived from a color wheel as listed below and in the table of FIG. 1:

TABLE 1

| Type | Colors from Color Wheel |
|---|---|
| 1 | Colors directly next to each other (i.e. yellow and |
| | yellow-orange; yellow and yellow-green; violet and |
| | blue-violet, etc.) |
| 2 | Colors that form right (90 degree) angles with each |
| | other (i.e. yellow and red-orange; blue and violet-red; |
| | green and orange, etc.) |
| 3 | Colors directly across from each other (i.e. yellow and |
| | violet; blue and orange; red and green, etc.) |
| 4 | Colors that form a T (i.e. blue, orange, and violet-red; |
| | yellow, violet, and red-orange; yellow, blue-green, and |
| | red-orange, etc.) |
| 5 | Colors that form an X (i.e. blue, orange, violet-red, and |
| | yellow, violet, blue-green, and red-orange, etc.) |

### Manual Color Analysis and Matching

FIG. 6 provides a flowchart of steps for the “manual method” wherein the system processor computes the “matching colors” based on a user's input of the dominate colors they perceive to be in an article. The user manually inputs into their electronic computing device 210, 220 (e.g. laptop, smartphone, tablet, etc.) the dominate colors they perceive to be in their article that they are trying to color match. For example, the user can select from a drop down menu posted on a webpage a list of colors, which may include the CMYK and/or Pantone color value, their commonly known name, and/or an image of the color. The remote server 240 receives the input, and computes the matching CMYK and/or Pantone color values that match the user's inputted color.

The user may also have the ability to request converting from the CMYK value to the Pantone color value, or vice versa. For example, if the server transmits back to and displays on the user's device a list of CMYK values, or color images with their CMYK values overlaid, that match the user's original inputted color, then the user can request that the CMYK values be converted to Pantone color values with one user input (e.g. 1-click action on a tab, icon, etc. that is displayed on a webpage or device screen).

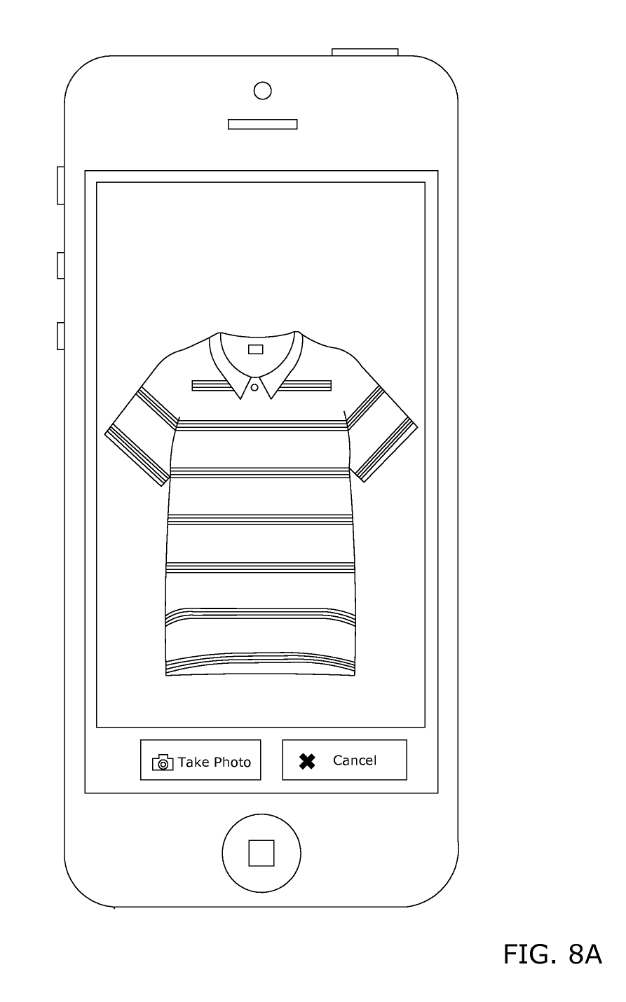

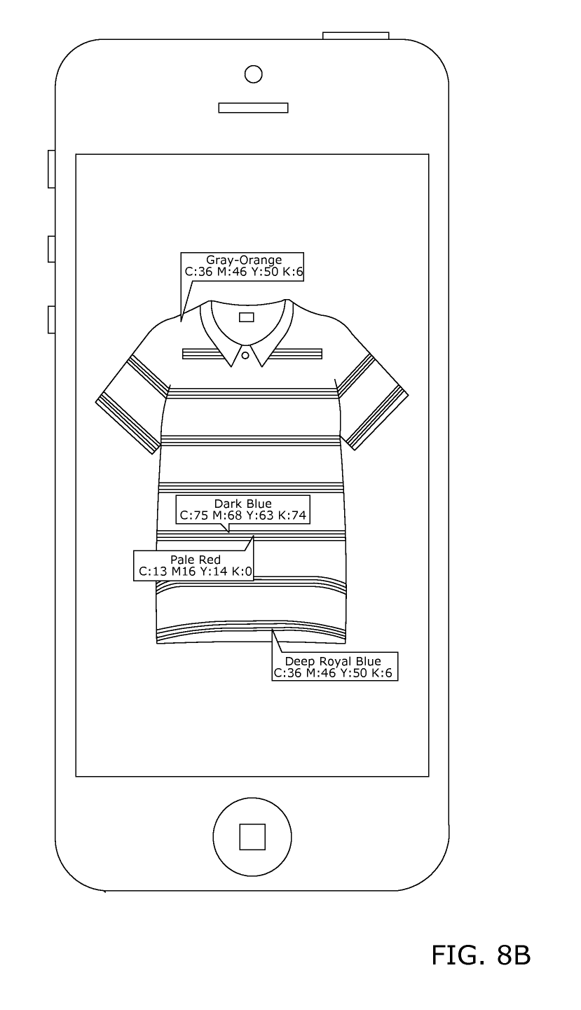

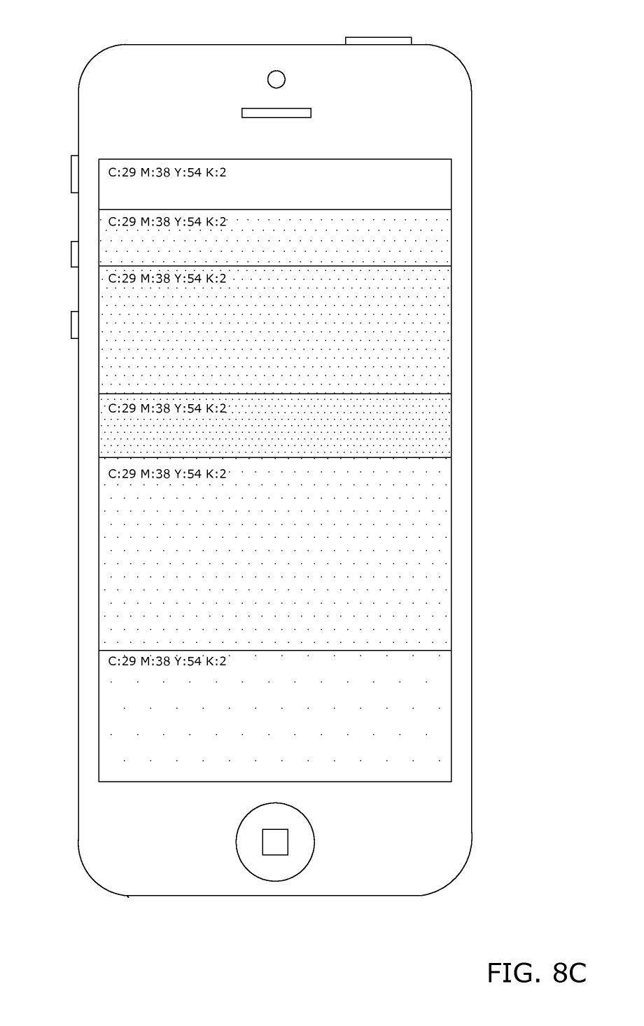

In step 610, the system server 240 displays a webpage, or a screen on a user's device 210,220 that is displayed by a mobile app, comprising a means for the user to indicate the color(s) in the article they are trying to match. The display may comprise, for example, a drop down menu of colors by their common name, and/or by their CMYK and/or Pantone value, and/or with an image of the actual color. For example, the CMYK and/or Pantone color value can be overlaid on an image of the actual color as per FIG. 8C.

In step 620, the mobile device's 210, 220 processor receives the user's manual input, or it is transmitted via the network 250 to the remote server 240, wherein it is received by the system processor.

Then, as illustrated in FIG. 6, step 630a, the user's device 210 in conjunction with the computer program product 350 installed thereon (e.g. mobile app for smartphone), can compute and display the matching colors, the color CMYK and/or Pantone color values, and/or an image of the actual colors. The color analysis therefore does not require the mobile device 210 to log into the remote server 240.

Alternatively, as illustrated in FIG. 6, step 630b (e.g. wherein the computer program product 350 is not installed on the laptop, desktop, etc. device 220) the user can still access the color matching feature on the website. They merely log into the website, and use its computer code via the network to manually input colors that they are trying to match. The processor of server 240 then computes the matching colors and their CMYK and/or Pantone color values, and transmits them back to the user's device 220.

In step 640, the matching colors are then displayed on the screen of the user's device 210,220 by their common name, and/or their CMYK and/or Pantone color value, and/or an image of the actual colors (step 640). For example, the CMYK and/or Pantone color value can be overlaid on an image of the actual color as per FIG. 8C. In step 650, the processor (mobile device's preferably, or remoter server's if the computer program product 350 is not installed on the device 210, 220) may also have the option of converting from CMYK to Pantone color values, or vice versa, and displaying the converted values with or without actual images of the color that each value represents.

The system may further identify fashion articles comprising the matching colors so as to create a coordinated ensemble, such as from a retailer's catalogue. For example, if the user's article was a shirt, the user's device 210, 220 may log into the remote server 240, search for, and display pants, shoes, jackets, etc. comprising an identified matching color (step 660—optional).
c) Automated (wrist skin tone): User's device scans open wrist image of user arm and computes their skin tone and undertone by capturing the color of their veins, which is assigned a CMYK and/or Pantone value. The device then computes and displays colors (and their CMYK and/or Pantone color value) that match the skin tone color value (e.g. FIG. 9).
d) Automated (with two clothing items):
   i) User scans one primary item, such as pants, with a smartphone (comprising scan app). The user scans a secondary item, such as a shirt, in an effort to make a coordinated ensemble. The program would then determine if the primary and secondary items match in color. If they do not, then the primary item would remain and the user would then find another secondary item to scan and compare.
   ii) The computer program product can also factor in the user's skin tone (see supra 3(b)) when computing matching colors of two clothing items. The device can compute and display the color compatibility between a primary and secondary fashion article, such as in percentages (e.g. 85% compatibility), and then the device can factor in the user's skin tone color value (e.g. dropping compatibility to 70%).

### Automated Color Analysis and Matching

FIG. 7 provides a flowchart of steps for the “automated method” taken by the user's electronic computing device in computing the main colors of an article (i.e. “article's colors”) and other colors (i.e. “matching colors”) that would match the main colors. The automated method of color analysis comprises the User scanning their fashion article with a smartphone (comprising scan app) or by logging into the remote server 240 to access the Color Analysis Module; the smartphone's processor computes and displays the CMYK and/or Pantone value for each color in the article of clothing; and then computes and displays matching colors.

The automated embodiment thus comprises a user's electronic computing device (e.g. a “mobile device”) 210 with a computer program product 350 (e.g. “mobile app”) installed within the device's memory and/or 220 (laptop, desktop, tablet, etc.), and its method of use, to scan a camera image of a fashion article (FIG. 7, step 710; see also FIG. 8A). The scanning functionality may be incorporated into the computer program 350, or it may comprise generic scanning software installed separately on device 210, 220. From the scanned image of the article, the device's 210, 220 processor identifies the color codes in the article (e.g. CMYK and/or Pantone values for each color) (step 720). The device's processor will display the CMYK and/or Pantone values overlaid on top of the image of the article, with the values indicating the color it represents (e.g. screen shot FIG. 8B) (step 730). The device's processor then computes the other types of colors that will match the identified color code (“matching colors”) (step 740). The device's processor then displays the color images (e.g. blocks of color samples) with their CMYK and/or Pantone values (e.g. FIG. 8C) (step 750). The user can also elect to convert displayed CMYK values to Pantone values, or vice versa (step 760) (optional).

In an additional aspect (optional), and as per FIG. 6, step 660 and FIG. 7, step 770, the user may then search online at the website hosted by the remote server 240 for fashion articles with specific matching CMYK and/or Pantone color codes to create a coordinated ensemble. The matching ensemble is actually derived from the brand, clothing store or manufacturer; therefore, if an individual selects a pair of pants, the retailer knows what other tops (or accessories) they have in the store that would fit well with that particular item, in color, style, and texture. Hence, the shopper would not need the assistance of a store associate, or stylist.

### Exemplification of Computer Program Product Color Matching

A user's electronic computing device with the computer program product for color matching installed within memory on the device may be used in the following steps to compute a coordinated outfit:

1) the device scans an image of a color, such as one in a primary article of fashion that the user wants build an outfit around;

2) the processor of the device computes that color identification code(s) of the article, such as the CMYK and/or Pantone code(s);

3) the device will display different styles for the user to select from, such as “Basic”, “Traditional”, “Stylish”, “Chic”, etc.;

4) in response to the user selecting a style, then the processor will compute and display the colors from a color wheel that match the colors identified in step (2), for example:
i) If the user selected “Basic”, then the device would display mono, complementary, and analogous matching colors;
ii) If the user selected “Traditional”, then the device would display triadic matching colors;
iii) If the user selected “Stylish”, then the device would display tetradic or rectangular from the color wheel matching colors; and,
iv) If the user selected “Chic”, then the device would display square matching colors from the color wheel.

### Automated Color Comparison of Two Articles

In another aspect, the computer program product 350 installed on the user's electronic computing device, and/or color matching modules accessed on the remote server 240 via the network, has the ability to scan a user's primary article of clothing, such as a pair of pants, and then to scan a secondary item of clothing, such as a shirt that the user's believes may be a good color match for the primary item. The device's processor would then compute whether the two items match. If they do not, the device will display an option of allowing the user to scan another secondary item, and then it will re-compute whether or not a match exists, or rate the extent to which is does.

### Complexion Compatibility

As illustrated in the flowchart of computer steps in FIG. 9, another aspect of the present invention is the ability to compute the user's skin tone color, and use this in matching articles of fashion. In step 910, the devices 210 and/or 220 scan an image of the user's wrist and analyze their skin tone and vein color for their undertone. Again, the scanning functionality can be part of the computer program product, or it can be a generic scanning software installed on the device 210, 220. The skin tone is then assigned a CMYK and/or Pantone color value by the device processor (step 920). The device's 210, 220 then computes and displays the colors that match the skin tone color value, and their CMYK and/or Pantone color value (step 930). The user can also elect to convert displayed CMYK values to Pantone values, or vice versa (step 940) (optional).

In another embodiment, the user's undertone is also analyzed by the device processor from a scanned image of their skin on their wrist. The undertone measures the color of the veins residing beneath the surface of the skin. For example, a user's skin that is analyzed to comprise pink, blue, or red tinge, is labelled a “cool” undertone for which specific hues of pink, purple, blue and green fashion articles are recommended to the user by the system. If the user's skin undertone is determined to be “warm” based on upon the detection of green or olive hues, then the system will recommend fashion articles in colors comprising orange, yellow, olive green, etc.

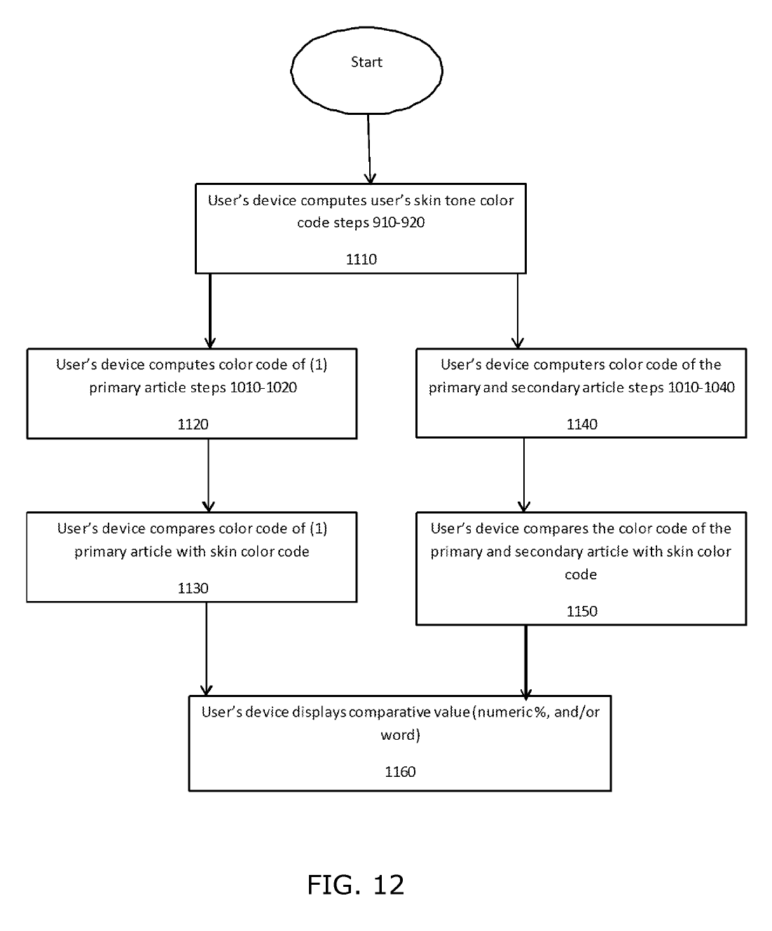

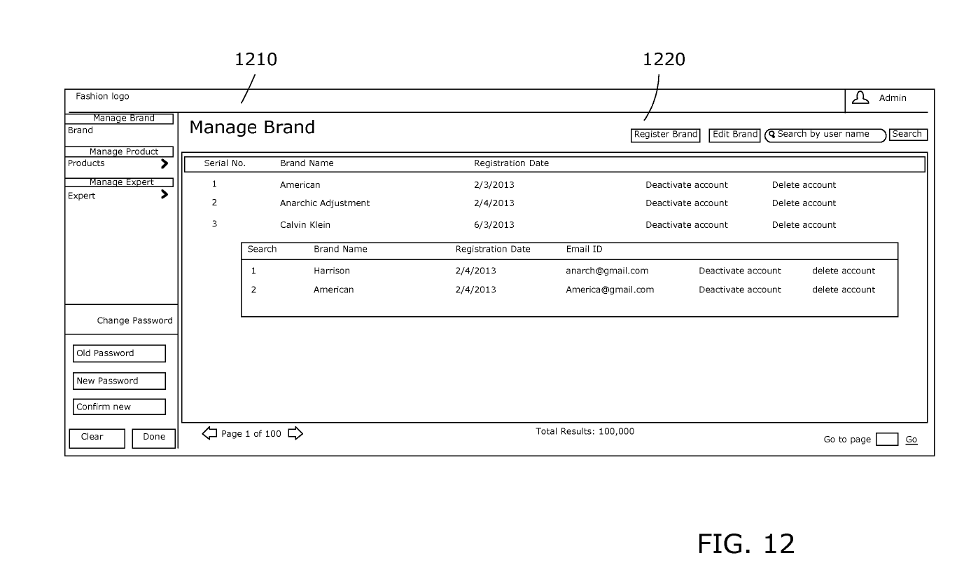

In yet a further aspect of automated color comparison of one or two articles of fashion, the skin tone color value can be used as an additional variable when computing the color compatibility of the primary and secondary articles (See FIGS. 11 and 12).

### Automated Color Comparison of Two Articles

In another embodiment, the user can utilize their mobile device 210 or 220 with the computer program product 350 installed thereon to compute if two articles of fashion color coordinate. In an alternative embodiment, if the user's device does not have the program 350 installed thereon, then the device 210, 220 can connect with the remote server 240 to compute the same.

As illustrated in FIG. 10, step 1010, the user's device 210, 220 scans an image of a primary fashion article, such as pants. In step 1020, the user's device's processor computes the CMYK and/or Pantone color values of the primary article, and may optionally display the value(s).

In step 1030, the user's device 210, 220 then scans a secondary fashion article that the user is trying to match to the primary article. In step 1040, the user's device's processor computes the CMYK and/or Pantone color values of the secondary article, and may optionally display the value(s).

In step 1050, the user's device's processor compares the primary article's color value(s) with the secondary article's color value(s) and determines if there is a color match. The determination may be based on a percentage and/or comparative language.

In step 1060, the user's device displays a numerical value or comparative language, such as “Poor, Fair, Good, Very Good, Perfect Match”, wherein “Poor” would be about 0-45%, “Fair” would be about 46-70%, “Good” would be about 71-80%, “Very Good” would be about 81-90%, and a “Perfect” match would be above 90%.

Automated Color Comparison of One or Two Articles with Skin Color

The steps of FIGS. 9 and 10 can be combined into one process as per FIG. 11. For example, the user's skin tone can be compared with one article of fashion—such as one that lies next to the user's skin (e.g. shirt, dress, blazer, sweater, etc.). In step 1110, a skin color analysis is completed as per FIG. 9, steps 910-940). In step 1120, a primary article's color value(s) is computed as per FIG. 10, steps 1010-1020. The device's processor then determines if there is a color match of the article to the user's skin tone (step 1130). It is noted that the skin tone analysis (step 1110) can follow the primary article analysis (step 1120), or either may be retrieved from the device's memory. The user's device then displays the comparative value (as numeric percentage, and/or word) in step 1160.

In another embodiment, the user's skin tone is compared with the primary and secondary articles of fashion. In step 1140, the user's device computers color values of the primary and secondary articles as per FIG. 10, steps 1010-1040. In step 1150, the user's device compares the color values of the primary and secondary article with skin color value. The user's device then displays the comparative value (numeric percentage, and/or word) in step 1160.

### Web Administrator and Third Party Brands

As illustrated in FIGS. 12-15, the present invention may also comprise a web-based service that involves a web administrator who creates an account on a remote database for third parties to advertise their fashion line. The third parties, such as manufactures and retailers, may compensate the first website operators for uploading and maintaining their fashion line within the first website's database. In the exemplifications of FIGS. 12-15, the administrator has the ability to create, edit and deactivate accounts comprising different lines of fashion, such as different third party's (retailer's, designer's, manufacturer's, etc.) inventory of advertised fashion articles.

Each third party account may by be designated as a “Brand” (e.g. FIG. 12, 1210—“Manage Brand”). The administrator has the ability to “Register a Brand” that creates an account for the third party on the website (FIG. 12, 1220). The third party may then log into their account on the remote server (FIG. 2, 240), wherein the system will display only their account. The third party and/or the administrator may then edit, add, delete fashion articles, their descriptions, prices, etc.

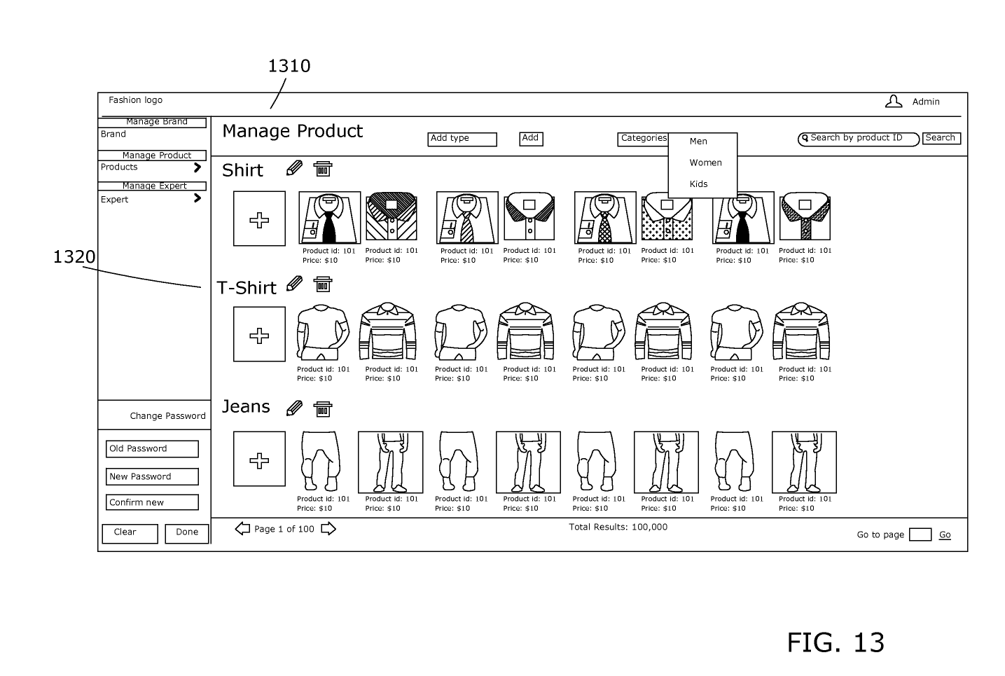

FIG. 13 provides an exemplification of a webpage displayed to enable the third party or administrator to manage their online inventory of advertised fashion articles, “Manage a Product” 1310. The webpage displays all of the articles that a user can view from on the website, by their category type—shirt, T-shirt, jeans, etc. By clicking on the “+” sign, 1320, the third party or administrator, is re-directed to the webpage or shown a popup window enabling them to upload an image of a new product for that category and to add information about it.

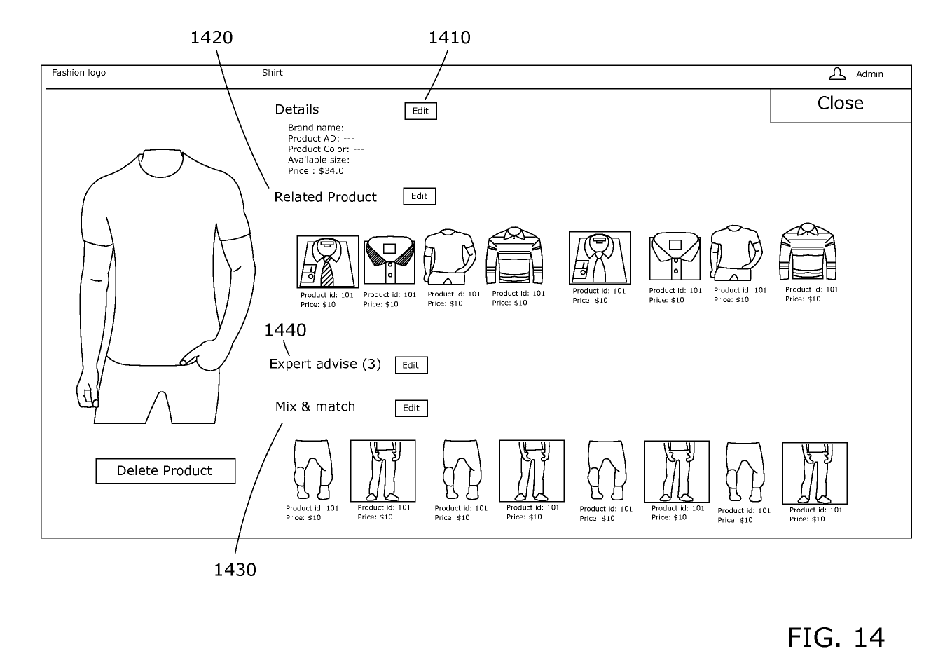

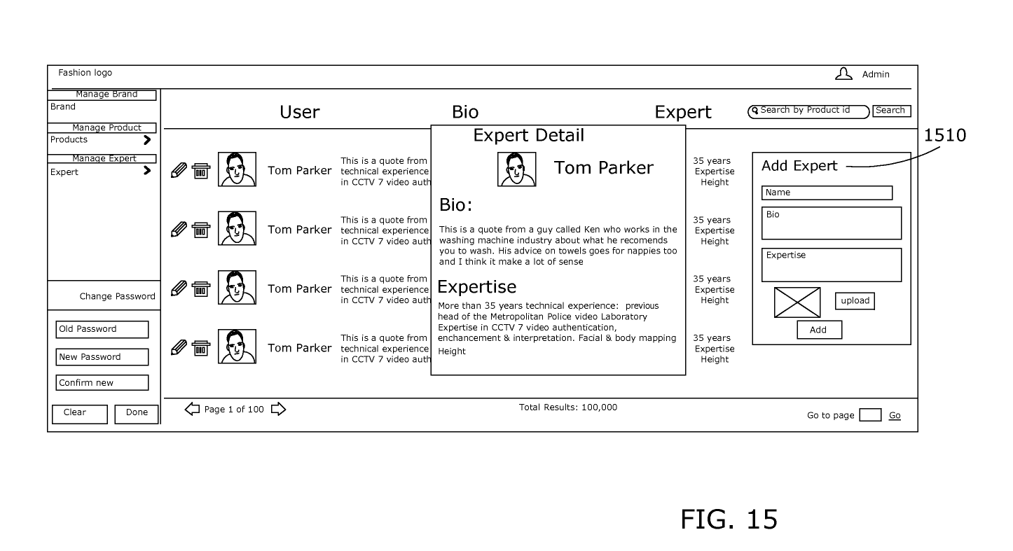

They may also edit this information for previously created products, as shown in FIG. 14, 1410, such as by changing an identification code (e.g. as encoded in clothing tags 410 and 420), price, size, color, related products 1420 (within the same category from the same third party), and mix & match 1430 (articles that the third party and/or stylists have indicated as making a coordinated ensemble with the product), and expert advice from stylists 1440, etc.

FIG. 15 displays the webpage the third party or administrator sees when adding, deleting or editing information at popup window or other input area 1510 about a stylist who provides fashion advice for one or more brands. The stylist's information may comprise their uploaded image, their biographical information, their areas of expertise, etc. The third party or administrator then links a stylist advice with a product identification number. In one embodiment, the stylist is given the product in advance before it is sent to the store. They are then given about 10-20 minutes to review the item and make a recommendation, which is then uploaded to the system database.

The website may further provide a means to purchase an advertised fashion article online, via a link displayed to the third party's or other entity's website, or to purchase it directly on the administrator's website.

The website administrator may further provide the third party the temporary 410 and permanent 420 tags comprising links to the webpages advertising their product on the website.

### CONCLUSION

The aforementioned diagrams, figures, and flowcharts illustrate the architecture, functionality, and operation of possible implementations of computer systems, methods, and devices comprising computer program products (aka computer code) and/or computer-usable medium having computer-readable program code stored thereon according to various embodiments of the present invention. In this regard, a step(s) in a flowchart may represent a module, segment, or portion of code, which comprises one or more executable instructions for implementing the specified logical function(s).

It should also be noted that, in some alternative implementations, the functions noted in the flowcharts may occur out of the order in which they are presented. For example, steps shown in succession may, in fact, be executed substantially concurrently, or the steps may sometimes be executed in the reverse order, depending upon the functionality involved. It will also be noted that each step of a computer flowchart, and combinations of steps, can be implemented by special purpose hardware-based systems that perform the specified functions or acts, or combinations of special purpose hardware and computer instructions.

And, in the above description, an embodiment is an example or implementation of the inventions. The various appearances of “one embodiment,” “an embodiment” or “some embodiments” do not necessarily all refer to the same embodiments.

What is claimed is:

1. A fashion article with a permanent tag comprising a URL encoding a webpage disclosing an article's features selected from the group consisting of: care instructions, material composition, size, designer label, style, type, texture, and distinguishing characteristics.

2. The article of claim 1 further comprising a temporary tag comprising a QR code encoding the URL.

3. The article of claim 1, wherein the webpage further comprises recommendations from professional stylists to create a coordinated ensemble for the article.

4. The article of claim 2, wherein the webpage comprises a means for a user to indicate the main colors in the article, and the device to compute and display colors that match the main colors.

5. The article of claim 4, wherein the color is indicated by its CMYK and/or Pantone identification codes.

6. A computerized method of displaying a webpage disclosing a fashion article's features:
a) scanning a quick response (QR) code displayed on an article with an electronic computing device;
b) interpreting the URL encoded with the QR code by a processor of the electronic computing device;
c) navigating to the URL of a remote system server using the web-browser of the electronic computing device;
d) displaying by the remote system server the article's features on the webpage encoded by the URL; and,
e) wherein the features are selected from the group consisting of: care instructions, material composition, size, designer label, style, type, texture, and distinguishing characteristics.

7. The computerized method of claim 6, wherein the webpage further comprises recommendations from professional stylists to create a coordinated ensemble for the article.

8. The computerized method of claim 6, wherein the webpage further comprises a means for a user to indicate the main colors in the article, and the device to compute and display colors that match the main colors.

9. The computerized method of claim 8, wherein the colors are indicated by CMYK and/or Pantone identification codes.

10. The computerized method of claim 8, further comprising displaying one or more webpages comprising additional articles that match in style, type, and color.

11. A computerized method of analyzing the main colors in a fashion article, comprising:
a) scanning an image of a fashion article by utilizing a camera on an electronic computing device;
b) computing by a processor of the electronic computing device the main colors of the article;
c) displaying the identity of the main colors overlaid onto an image of the article;
d) computing by the processor the matching colors to the main colors;
e) displaying the images of the matching colors overlaid with the name of the color;
f) wherein the main and matching colors are each identified by CMYK and/or Pantone identification codes; and,
g) wherein the fashion article is selected from the group consisting of pants, shirt, coats, dresses, jackets, sweaters, shoes, jewelry, pursues, and fashion accessories.

12. The computerized method of claim 11, further comprising directing the web-browser of the electronic computing device to a website of a remote system server displaying one or more webpages comprising additional items comprising the matching colors to create a coordinated ensemble.

13. A computerized method to determine the color compatibility of two fashion articles, comprising:
a) scanning an image of a first fashion article by utilizing a camera on an electronic computing device;
b) computing by a processor of the device the color identification codes of the main colors of the first article;
c) scanning an image of a second fashion article by utilizing the camera of the device;
d) computing by the processor of the device the color identification codes of the main colors of the second article;
e) computing a comparative value by the processor of the device the color identification codes of the first and second articles; and,
f) displaying the comparative value on the device, wherein the value indicates a degree of color matching between the first and second article.

14. The computerized method of claim 13, wherein the color identification codes colors are CMYK and/or Pantone identification codes.

15. A computerized method to determine a user's skin tone color identification, comprising:
a) scanning an image of a user's skin by utilizing a camera on an electronic computing device;
b) computing by a processor of the device the color identification codes of the user's skin; and,
c) displaying on the device the skin color identification codes, wherein the codes are identified by CMYK and/or Pantone identification codes.

16. The computerized method of claim 15, further comprising:
d) scanning an image of a first fashion article by utilizing the camera on the electronic computing device;
e) computing by the processor of the device the color identification codes of the main colors of the first article;
e) computing a comparative value by the processor of the device the color identification codes of the user's skin and the first article; and,
f) displaying the comparative value on the device, wherein the value indicates a degree of color matching between the user's skin and the first article.

17. The computerized method of claim 15 further comprising, comparing the color compatibility of two fashion articles with the user's skin color, comprising:
a) scanning an image of a first fashion article by utilizing a camera on an electronic computing device;
b) computing by the processor of the device the color identification codes of the main colors of the first article;
c) scanning an image of a second fashion article by utilizing the camera of the device;
d) computing by the processor of the device the color identification codes of the main colors of the second article;
e) computing a comparative value by the processor of the device the color identification codes of the first and second articles; and,
f) computing a comparative value by the processor of the device of the value of step (e) with the color identification codes of the color identification codes of the user's skin of step 15(b); and,
g) displaying the comparative value on the device, wherein the value indicates a degree of color matching between the first and second article and the user's skin.

18. A computer program product to compute matching colors of a fashion article, comprising a non-transitory machine-readable medium storing machine instructions that, when executed by a server system comprising one or more programmable processors, cause the server system to perform functions comprising:
a) scanning an image of a fashion article by utilizing a camera on an electronic computing device;
b) computing by a processor of the electronic computing device the main colors of the article;
c) displaying the identity of the main colors overlaid on to an image of the article;
d) computing by the processor the matching colors to the main colors;
e) displaying the images of the matching colors overlaid with the name of the color;
f) wherein the main and matching colors are each identified by CMYK and/or Pantone identification codes; and,
g) wherein the fashion article is selected from the group consisting of pants, shirt, coats, dresses, jackets, sweaters, shoes, jewelry, pursues, and fashion accessories.

19. A computer program product to determine the color compatibility of two fashion articles comprising a non-transitory machine-readable medium storing machine instructions that, when executed by a server system comprising one or more programmable processors, cause the server system to perform functions comprising:
a) scanning an image of a first fashion article by utilizing a camera on an electronic computing device;
b) computing by a processor of the device the color identification codes of the main colors of the first article;
c) scanning an image of a second fashion article by utilizing the camera of the device;
d) computing by the processor of the device the color identification codes of the main colors of the second article;
e) computing a comparative value by the processor of the device the color identification codes of the first and second articles; and,
f) displaying the comparative value on the device, wherein the value indicates a degree of color matching between the first and second article.

20. The computer program product of claim 19 wherein the color identification codes are CMYK and/or Pantone identification codes.

21. A computer system for creating a coordinated ensemble, the system comprising:
a) one or more user's electronic computing devices, having installed within memory thereon:
i) a color analysis module stored in memory of the electronic computing device and providing functionality to automatedly identify the matching colors of the ensemble;
ii) a first processor;
b) a remote system server, having installed within memory thereon:
i) a color analysis module providing functionality to identify the matching colors of a user's manually inputted main colors from the electronic computing device;
ii) a database comprising records of fashion articles' features and third parties' inventory of articles; and
iii) a webpage document generation module comprising one or more webpages in response to the user input;
iv) a second processor; and,
c) a network transmitting electronic communications between the users' electronic computing devices and the remote system server.

22. The system of claim 21, wherein the color analysis module comprises computer code encoding instructions for the processors to:
a) scan an image of a fashion article by utilizing a camera on an electronic computing device;
b) compute by the processor of the electronic computing device the main colors of the article;
c) display the identity of the main colors overlaid on to an image of the article;
d) compute by the processor the matching colors to the main colors;
e) display the images of the matching colors overlaid with the name of the color; and,
f) wherein the fashion article is selected from the group consisting of pants, shirt, coats, dresses, jackets, sweaters, shoes, jewelry, pursues, and fashion accessories.

23. The computer system of claim 21 further comprising on the user's electronic computing device,
a) ii) a QR module stored in memory of the electronic computing device and providing functionality to automatedly navigate to a webpage displaying features of a fashion article.

24. The computerized system of claim 23, wherein the QR module of displaying the webpage, comprises functionality for:
a) scanning a quick response (QR) code displayed on an article with an electronic computing device;
b) interpreting the URL encoded with the QR code by the processor of the electronic computing device;
c) navigating to the URL of a remote system server using the web-browser of the electronic computing device;
d) displaying by the remote system server the article's features on the webpage encoded by the URL; and,
e) wherein the features are selected from the group consisting of: care instructions, material composition, size, designer label, style, texture, and distinguishing characteristics.
